(19) United States
(12) Patent Application Publication
(10) Pub. No.: US 2013/0304990 A1
(43) Pub. Date: Nov. 14, 2013

(54) Dynamic Control of Cache Injection Based on Write Data Type

(71) Applicants: Brian Mitchell BASS, Apex, NC (US); Kenneth Anthony LAURICELLA, Colchester, VT (US); Ross Boyd LEAVENS, Cary, NC (US)

(72) Inventors: Brian Mitchell BASS, Apex, NC (US); Kenneth Anthony LAURICELLA, Colchester, VT (US); Ross Boyd LEAVENS, Cary, NC (US)

(73) Assignee: INTERNATIONAL BUSINESS MACHINES CORPORATION, Armonk, NY (US)

(21) Appl. No.: 13/466,365

(22) Filed: May 8, 2012

(51) Int. Cl. G06F 12/08

(52) U.S. Cl. 711/118; 711/E12.017

(57) ABSTRACT

Selective cache injection of write data generated or used by a coprocessor hardware accelerator in a multi-core processor system having a hierarchical bus architecture to facilitate transfer of address and data between multiple agents coupled to the bus. A bridge device maintains configuration settings for cache injection of write data and includes a set of n shared write data buffers used for write requests to memory. Each coprocessor hardware accelerator has m local write data cacheline buffers holding different types of write data. For write data produced by a coprocessor hardware accelerator, cache injection is accomplished based on configuration settings in a DMA channel dedicated to the coprocessor and a bridge controller. The access history of cache injected data for a particular processing thread or data flow is also tracked to determine whether to down grade or maintain a request for cache injection.

### BACKGROUND

1. Field of the Invention

The embodiments herein relate to acceleration of input/output functions in multi-processor computer systems, and more specifically, to a computer system and data processing method for controlling the types of write data selected for cache injection in a processor expected to next use a block of cached data.

2. Description of the Related Art

General purpose microprocessors are designed to support a wide range of workloads and applications, usually by performing tasks in software. If processing power beyond existing capabilities is required then hardware accelerator coprocessors may be integrated in a computer system to meet processing requirements of a particular application.

In computer systems employing multiple processor cores, it is advantageous to employ multiple hardware accelerator coprocessors to meet throughput requirements for specific applications. Coprocessors utilized for hardware acceleration transfer address and data block information via a bridge. A main bus then connects the bridge to other nodes that are connected to a main memory and individual processor cores that typically have local dedicated cache memories.

Ancillary to instruction execution, a processor must frequently move data from a system memory or a peripheral input/output (I/O) device into the processor for processing, and out of the processor to the system memory or the peripheral I/O device after processing. In this regard, the processor often has to coordinate the movement of data from one memory device to another memory device. In contrast, direct memory access (DMA) transfers transfer data from one memory device to another across a system bus without intervening communication through a processor.

In computer systems, DMA transfers are often utilized to overlap memory copy operations from I/O devices with useful work by a processor. In other words, a processor may continue processing instructions uninterrupted while a DMA transfer to processor's cache is completed. A DMA transfer is usually initiated by an I/O device, such as a network controller or a disk controller and the completion of the transfer is communicated to the processor by way of an interrupt request. The processor will eventually handle the interrupt by performing any required processing on the data transferred from the I/O device before the data is passed to an application utilizing the data. The user application requiring the same data may also cause additional processing on the data received from the I/O device.

Many computer systems incorporate cache coherence mechanisms to ensure copies of data in a local processor cache are consistent with the same data stored in a system memory or other processor caches. In order to maintain data coherency between the system memory and the processor cache, a DMA transfer to the system memory will result in the invalidation of the cache lines in the processor cache containing copies of the same data stored in the memory address region affected by the DMA transfer. However, those invalidated cache lines may still be needed by the processor in the near future to perform I/O processing or other user application functions. Accordingly, when the processor needs to access the data in the invalidated cache lines, the processor has to fetch the data from the system memory, which has much higher access latency then a local cache.

Cache injection is a technique in which data is transferred into a cache during a DMA transfer into system memory, thus reducing or eliminating the delay associated with subsequently loading the data into cache for use by the processor. By directly loading existing cache lines that would otherwise be invalidated by a DMA write to associated blocks of memory, the affected cache lines do not have to be marked invalid, thus avoiding cache miss penalties that would otherwise occur and eliminating the need to reload the cache lines in response to the miss. Cache injection can also avoid a cache load operation when space is available for allocation of new cache lines for DMA transfer locations that are not yet mapped into the cache. When a cache line to be injected is not present in the cache and space is either unavailable or the cache controller is unable to allocate new lines for DMA transfer locations that are not already mapped, the controller need take no action; standard DMA transfer processing takes place and main memory is guaranteed to have the most up-to-date copy of the data.

Cache injection is therefore beneficial in single processor systems because the latency associated with processing DMA operations is reduced overall, thus improving I/O device operations and operations where DMA hardware is used to transfer memory images to other memories. The cache injection occurs while the DMA transfer is in progress, rather than occurring after a cache miss, when the DMA transfer completion routine (or other subsequent process) first accesses the transferred data.

However, using conventional cache injection techniques in a multiprocessor system such as simultaneous multi-thread processor (SMP) or non-uniform memory access (NUMA) system provides additional challenges. In any multiprocessor environment, the cache loaded by the cache injection technique may not be located near the processor executing the DMA transfer completion routine or other routine that operates on or examines the transferred data. In a NUMA system, the memory image from the DMA transfer may not be in a memory that is quickly accessible to the processor that consumes or processes the transferred data. For example, if the data is transferred to the local memory of another processor, accesses to those address ranges would typically require transfer via a high-speed interconnect network or through a bus bridge, increasing the time required to access the data for processing.

Some of the write data produced by the coprocessor hardware accelerator may need to be used by a general purpose processor in the system. In the absence of a cache injection mechanism, this would require a processor to fetch/refetch the data from system memory into its cache once it is signaled to do so by a polling mechanism, interrupt, or other means commonly used to indicate completion of an operation. However, injecting all write data from a coprocessor could cause contamination of the processor cache, removing cache lines that are still needed and replacing them with unnecessary data from the coprocessor. Accordingly, it is desirable to control which write data types produced by a hardware accelerator coprocessor will be injected into the local cache of a processor expected to next use the write data.

### SUMMARY

In view of the foregoing, disclosed herein are embodiments of a multi-processor computer system and method incorporating selective cache injection based on the type of write data generated by a coprocessor hardware accelerator. In the embodiments, a determination is made in a coprocessor hardware accelerator as to whether or not a bus operation is a data transfer from a first memory to a second memory without intervening communications through a processor, such as a direct memory access (DMA) transfer. If a DMA transfer is detected, the system determines the type of write data generated and assigns priorities for bus access and cache injection based on programmable settings in each coprocessor and in the bus bridge. Assuming a block of write data is selected for cache injection and the coprocessor cache memory does not include a copy of data from the data transfer, a cache line is allocated within the cache memory to store a copy of the data from the data transfer and the data is copied into the allocated cache line as the data transfer proceeds. If the cache memory does include a copy of the data being modified by the data transfer, the cache controller updates the copy of the data within the cache memory with the new data during the data transfer. The DMA engine makes a request to write data within a cacheline boundary and a write request arbiter and control logic arbitrates between multiple coprocessors to pass write requests to the bus bridge logic and moves the write data from the co-processor to the bridge.

### BRIEF DESCRIPTION OF THE SEVERAL VIEWS OF THE DRAWINGS

The embodiments disclosed herein will be better understood from the following detailed description with reference to the drawings, which are not necessarily drawn to scale and in which:

FIG. 1 is a schematic block diagram illustrating an embodiment of a distributed multi-processor computer system having shared memory resources connecting through a bridge agent coupled to a main bus;

FIG. 2 is a schematic block diagram and abbreviated flow diagram illustrating logic elements of a coprocessor hardware accelerator to facilitate control of write requests for cache injection.

FIG. 3 is a schematic block diagram illustrating logic elements and data flow within a memory bridge to facilitate control of a write request for cache injection to a local cache of a processor core

FIG. 4 shows a flow chart for cache inject control implemented in bridge controller logic.

### DETAILED DESCRIPTION

The embodiments herein and the various features and advantageous details thereof are explained more fully with reference to the non-limiting embodiments that are illustrated in the accompanying drawings and detailed in the following description.

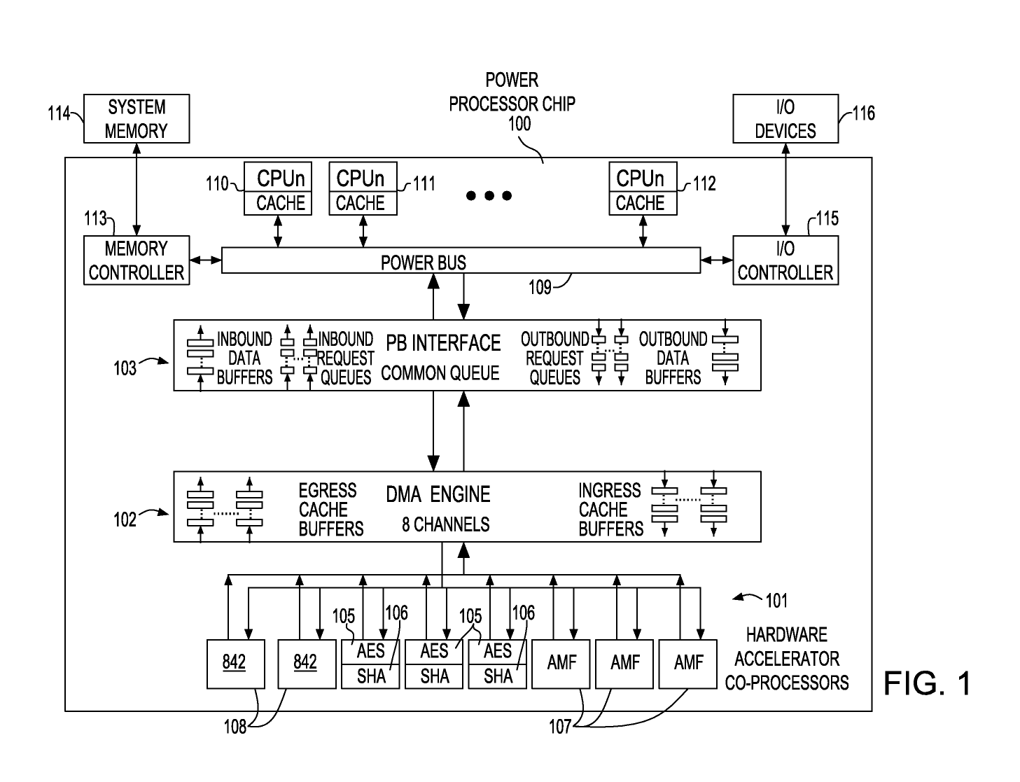

An example of a computer architecture employing dedicated coprocessor resources for hardware acceleration is the IBM Power Server system. However, a person of skill in the art will appreciate embodiments described herein are generally applicable to bus-based multi-processor systems with shared memory resources. A simplified block diagram of hardware acceleration dataflow in the Power Server System is shown in FIG. 1. Power Processor chip 100 has multiple CPU cores (O-n) and associated cache 110, 111, 112 which connect to PowerBus® 109. Memory controller 113 provides the link between PowerBus® 109 and external system memory 114. I/O controller 115 provides the interface between PowerBus® 109 and external I/O devices 116. PowerBus® 109 is the bus fabric that facilitiates data, address, and control movement between cache level memory, I/O and memory controllers, and the common queues for the accelerator engines in the PowerBus® Interface (PBI) 103.

Coprocessor complex 101 is connected to the PowerBus® 109 through a PowerBus® Interface (PBI) Bridge 103. (“coprocessor” as used herein, is synonymous with “coprocessor hardware accelerator,” coprocessor acceleration engine or “acceleration engine.”) The bridge contains queues of coprocessor requests received from CPU cores 110, 111, 112 to be issued to the coprocessor complex 101. It also contains queues of read and write commands and data issued by the coprocessor complex 101 and converts these to the appropriate bus protocol used by the system bus 109. The coprocessor complex 101 contains multiple channels of coprocessors, each consisting of a DMA engine and one or more engines that perform the co-processor functions.

Coprocessor acceleration engines 101 may perform cryptographic functions and memory compression/decompression or any other dedicated hardware function. DMA engine(s) 102 read and write data and status on behalf of coprocessor engines 101. PowerBus® Interface (PBI) 103 buffers data routed between the DMA engine 102 and PowerBus® 109 and enables bus transactions necessary to support coprocessor data movement, interrupts, and memory management I/O associated with hardware acceleration processing.

Advanced encryption standard (AES) and secure hash algorithm (SHA) cryptograph accelerators 105, 106 are connected pairwise to a DMA channel, allowing a combination AES-SHA operation to be processed moving the data only one time. Asymmetric Math Functions (AMF) 107 Perform RSA cryptography and ECC (elliptical curve cryptography). 842 accelerator coprocessors 108 perform memory compression/decompression. A person of skill in the art will appreciate various combinations of hardware accelerators may be configured in parallel or pipelined without deviating from the scope of the embodiments herein.

According to embodiments, the decision to cache inject (write data) from a hardware accelerator coprocessor to a core processor resident on the primary bus is a two step process. The coprocessor makes a DMA or Cache Inject Write request to the PBI bridge controller 103 providing the interface between a coprocessor and the primary bus. Based on its write configurations, the PBI bridge controller 103 either rejects the request to Cache Inject and the write data from the coprocessor is written to main memory via DMA transfer, or, if the request is granted, the write data is written to the local cache of the core processor on the primary bus expected to next use the write data. The decision is based also on a write history table maintained by the PBI bridge controller, which keeps track of earlier attempts to cache inject and whether the core processor has a cache line available and whether the core processor previously accessed cache injected data. The history table is maintained only for coprocessor requests associated with a particular coprocessor request block (CRB).

In order for the accelerators to perform work for the system, the coprocessor complex 101 must be given work from a hypervisor or virtual machine manager (VMM) (not shown), implemented in software to manage the execution of jobs running on the coprocessor complex 101. A request for coprocessor hardware acceleration is initiated when a coprocessor request command is received by the PBI bridge 103. Permission to issue the request, the type of coprocessor operation, and availability of a queue entry for the requested type of coprocessor operation are checked and assuming all checks are passed, the command is enqueued and a state machine is assigned to the request, otherwise the coprocessor job request is rejected. If a request is successfully enqueued, when a coprocessor is available the job will be dispatched to the DMA engine, i.e., PBI bridge 103 signals DMA engine 102 that there is work for it to perform and DMA engine 102 will remove the job from the head of the job request queue and start processing the request. If a requested input queue is full, the PowerBus® Interface will issue a PowerBus® retry partial response to the coprocessor request. When the data arrives, PBI 103 will direct data to the correct input data queue and inform DMA 102 the queue is non-empty.

DMA engine 102 then assigns the coprocessor request to an appropriate DMA channel connected to the type of coprocessor requested. DMA 102 tells the coprocessor to start and also begins fetching the data associated with the job request.

When the coprocessor has output data or status to be written back to memory, it makes an output request to DMA 102, and DMA 102 moves the data from the coprocessor to local buffer storage and from there to PBI 103 and PBI 103 writes it to memory. A coprocessor also signals to DMA 102 when it has completed a job request accompanied by a completion code indicating completion with or without error. Upon completion, the coprocessor is ready to accept another job request.

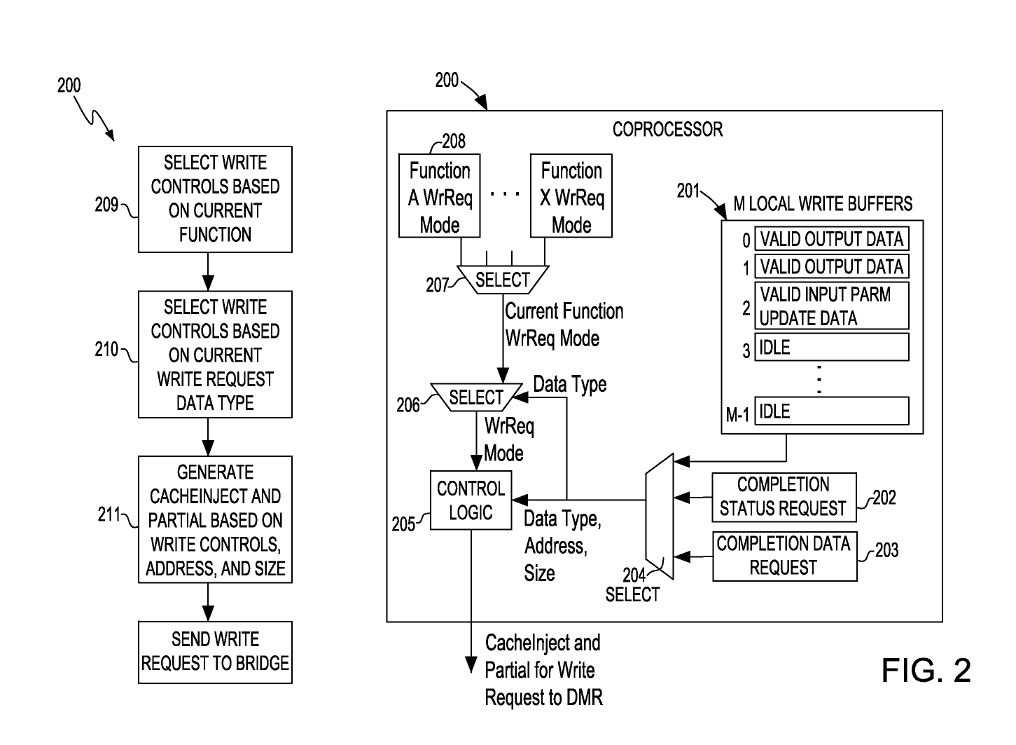

With reference to FIG. 2, coprocessor control logic 205 selects a write request mode based on the current function being processed by a requesting coprocessor and the data type associated with the request, which may be provided by one of three queues: the local write buffers, completion status request or completion data request. The m local write buffers 201 provide input to a select multiplexer 204. Completion status request 202 and completion data request 203 are also provided to the same select multiplexer 204. Multiple write requests are input to multiplexer select 207, which selects write controls based on the hardware function being performed by the coprocessor 200. Control logic 205 then issues a request for cache inject or partial cache inject based on the write controls and data type. The cache inject request is initiated by the coprocessor and the write request arbiter will choose between multiple coprocessors making a request and forward one to the bridge. The bridge will request the write data associated with the request and store it in the local bridge buffers until it is pushed out on to the PowerBus®.

Referring to Table 1 below, four types of write data, associated pointers and data formats according to embodiments are shown for the nested accelerator block incorporated in IBM Power server systems. The coprocessor request block (CRB) is a cache line of data that describes what coprocessor function is being performed and also contains pointers to multiple data areas that are used for input data to the acceleration engine or a destination for output data produced by the acceleration engine as well as reporting final status of the coprocessor operation. These pointers are generally associated with particular write data types as shown in Table 1.

Output data from the coprocessor hardware acceleration engine represents results of the accelerator's calculations on input data. The pointer associated with data output by a coprocessor is the Target Data Descriptor Entry (TGTDDE)—a pointer with a byte count to a single block of data or a list of multiple blocks of data that output data produced by the coprocessor engine will be stored to. TGTDDE behaves similarly to Source Data Descriptor Entry (SRCDDE) though used to write out target data produced by a coprocessor acceleration engine. When the DDE count is non-zero, the stream of target data produced by the coprocessor accelerator engine will be written out using as many target DDEs from the list as needed, going through the list sequentially.

With further reference to Table 1, updates to input parameter data represents additional results of the accelerator's calculations that are written to a storage area that also contains the parameter information used to configure the accelerator for this operation or updates to input data fetched and provided to the coprocessor hardware acceleration engine. Large blocks of input data can be split into multiple blocks that are processed by multiple CRBs. The input parameter update data is copied into the input parameter area of the CPB for the next sequential block of input data so that processing can resume based on the results of processing the previous block of input data. The associated pointer for updates to input parameter data is the Coprocessor Parameter Block (CPB). The CPB contains two areas: an input area that is used by the engine to configure the operation to be performed, and following that, an output area that can be used by the engine to write out intermediate results to be used by another CRB or final results, based on the operation that was performed.

Still referring to Table 1, completion status write data from the coprocessor operation represents the final status of the accelerator processing. A task that was dispatched via a coprocessor request block (CRB) needs completion status to determine when the operation has completed, whether there were any errors, how much output data was produced, etc. Completion status data also aids in managing multiple coprocessor hardware accelerator resources. The pointer associated with completion status is the Coprocessor Status Block (CSB) address, which is an address pointer that the final completion status of the coprocessor operation is written to. It is also used indirectly as a pointer to the start of the Coprocessor Parameter Block (CPB). The CPB starts at CSB+16.

TABLE 1
Coprocessor Write Data Types

| | | | Associated | |
|---|---|---|---|---|
| Write DataType | Description | Purpose | Pointer | Format/size |
| a. Output data | Results of | output data of | Target Data | one byte to a full |
| generated by a | coprocessor | coprocessor | Descriptor Entry | Cacheline |
| coprocessor | function | function to be | (TGTDDE) | staying within a |
| | | transferred to a | | cacheline |
| | | bus agent | | boundary |
| b. Updates to | Changes to input | Results of | Coprocessor | QuadWords |
| coprocessor | data sent to | coprocessor | Parameter Block | staying within a |
| input data | coprocessor or | function that may | (CPB) | cacheline |
| | add'tl | be used for | | bounday |
| | coprocessor | further | | |
| | results | processing by | | |
| | | another CRB | | |
| c. Completion | job completion | Job completed | Coprocessor | QuadWord on a |
| status data | status write | status, non-zero | Status Block | QW boundary |
| | | completion code | (CSB) | |
| | | for errors. | | |
| d. Additional | Additional write | Alternate | Coprocessor | Double Word on |
| completion data | after completion | Completion | Completion | a DW boundary |
| | status | indication | Block (CCB) | |
| | | method. | | |

Still referring to Table 1, Additional completion data represents an additional write after the completion status write, which uses address and data contained in the coprocessor request block (CRB) as an alternate means to indicate completion of a coprocessor operation with cache injection configuration settings distinct from other types of write data. The associated pointer: Coprocessor Completion Block (CCB)—may be used for data that can optionally be used as an extra indication of completion. If enabled, the data is written out to the address of the pointer after the CSB completion write. The CCB provides a flexible mechanism for programmers to specify how the completion status of a coprocessor function is communicated. The default notification occurs when a valid bit is written to the coprocessor status block (CSB). However, for some software applications it is more efficient to avoid having to poll for a valid bit because it may be time consuming and therefore impede performance. If an interrupt is generated, then the CCB is used to pass this “extra” completion information to the nested accelerator hardware bridge. In addition, if a number of related coprocessor jobs are executing in parallel, the application controlling that work may require the entire set of jobs to complete prior to sending final completion status, which could be facilitated by an additional write using the CCB. A person of skill in the art will appreciate the coprocessor completion block (CCB) may be used to implement several other reporting mechanisms for coprocessor completion status.

Another pointer associated with certain write data, the Source Data Descriptor Entry (SRCDDE), includes a byte count for the total number of source bytes to be processed. It also has a count field for the number of DDEs in the list. If the DDE count is 0, the SRCDDE pointer is the address for the start of the source data and the byte count is the number of bytes to be fetched starting at that address. If the DDE count is non-zero, the SRCDDE pointer is the address for the start of a list of DDEs and the DDE count is the number of DDEs in that list. Each DDE has an address for the start of a block of source data and a byte count. The DDEs are fetched and the data from each is concatenated together to send to the coprocessor acceleration engine.

TABLE 2
Table of Signals in Write Request Interfaces between Coprocessors and Bridge

| | | |
|---|---|---|
| | Direction | |
| Signal | (on DMA) | Description |

Request Interface

| | | |
|---|---|---|
| wr_req | out | write request pulsed for 1-cycle, attr held until req_ack. |
| wr_addr(0:63) | out | attr: starting address of the write operation |
| wr_partial | out | attr: partial write. 1 = write less than a full cacheline of data. |
| | | 0 = write a full cacheline of data. |
| wr_size(0:7) | out | attr: byte count 1-128 |
| wr_tag(0:3) | out | attr: identifies write buffer in bridge to use for request. |
| wr_relaxed | out | attr: relaxed ordering |
| wr_cache_inject | out | attr: cache inject |
| wr_comp_int | out | attr: completion interrupt, (address only, no data transfer) |
| wr_new_flow | out | attr: first write of a CRB |
| wr_requesterid(0:4) | out | attr: id for transaction ordering and flow |
| wr_256b | out | attr: 1 = data transfers will be 256 bits; 0 = 128 bits |
| wr_req_ack | in | ack for wr_req (all attributes have been received) |

Data Transfer Interface

| | | |
|---|---|---|
| wr_ram_re | in | indicates bridge is requesting write data (drive write data on |
| | | next cycle) |
| wr_ram_last | in | indicates last bridge data request for a write request. |
| wr_ram_data(0:255) | out | write data |
| wr_ram_ecc(0:31) | out | write ecc (8 bits for every 64 bits of data) |

Bridge Write Buffer Management Interface

| | | |
|---|---|---|
| wr_release | in | tag on wr_release_tag may be reused |
| wr_release_tag(0:3) | in | identifies write buffer that may be reused |
| wr_release_int | in | return an interrupt request credit |

Referring to Table 2, signals are defined for write request interfaces between the coprocessors and the bridge that are propagated through dedicated DMA channels. The request interface entries show request and acknowledge signals, along with attributes needed for the bridge to process the request. For example, wr_new_flow indicates the first write request of a coprocessor request block (CRB); wr_partial signifies whether or not to perform a partial cache line write; and wr_cache_inject is an attribute identifying the write request as one for which cache injection is requested, etc. The signal wr_requesterid(0:4) associates the write request with a particular coprocessor.

The data_transfer_interface section shown in Table 2 includes the actual data being written and associated ECC bits and two flags generated by the bridge to request the write data on a next cycle and indicating the last request from the bridge for the write data, respectively.

The Bridge Write Buffer Management Interface section of Table 2 lists signals sent to a coprocessor by the bridge signifying when a tag or write buffer may be reused.

As mentioned above, cache injection of write data from a coprocessor is determined by programmable settings for each coprocessor function and for each type of data produced by the coprocessor. A block level diagram of the write request cache inject control logic on the coprocessor side is shown in FIG. 2. Each Coprocessor 200 has m local write data cacheline buffers 201. These buffers may hold different types of write data, including output data from the coprocessor function; and updates to input parameter data fetched and provided to the coprocessor hardware accelerator. Requests for completion status of the coprocessor operation and additional completion data are initiated by the DMA engine, which also provides the data for such completion data write requests

The embodiments distinguish data types by the address locations they are written to. A table is maintained for all hardware accelerator coprocessor operations in the DMA logic for all write operation requests. Dedicated bit fields in the configuration table correspond to individual data types as defined above. The configuration table includes logical expressions defining conditional elements for when a cache inject write operation will occur.

TABLE 3
Cache Injection Controls for Coprocessor from DMA Configuration Register

| Config Field | Description |
|---|---|
| AES/SHA CSB | 00 = Always perform 8 or 16 byte partial DMA write |
| Write | 01 = Do 128 byte Cache Inject if CSB at end of cache line, else do partial |
| | DMA write |
| | 10 = Do 128 byte DMA write if CSB at end of cache line, else do partial |
| | DMA write |
| | 11 = reserved |
| AES/SHA CPB | 00 = Always do DMA writes, full or partial based on number of bytes and |
| Write | alignment |
| | 01 = Always do DMA writes, with partial on non-aligned cache lines and |
| | full 128 bytes on aligned cache lines (which may store dummy data at the |
| | end of the actual data) |
| | 10 = Do 128 byte Cache Inject when writing 128 aligned bytes, else do |
| | partial DMA write if not |
| | 11 = Do 128 byte Cache Inject when writing aligned cache lines(which may |
| | store dummy data at the end of the actual data), else do partial DMA writes |
| | if not aligned |
| AES/SHA Output | 0 = Always do DMA writes, full or partial based on number of bytes and |
| Data Write | alignment |
| | 1 = Do 128 byte Cache Inject when writing 128 aligned bytes, else do |
| | partial DMA write |
| AMF CSB Write | 00 = Always perform 8 or 16 byte partial DMA write |
| | 01 = Do 128 byte Cache Inject if CSB at end of cache line, else do partial |
| | DMA write |
| | 10 = Do 128 byte DMA write if CSB at end of cache line, else do partial |
| | DMA write |
| | 11 = reserved |
| AMF Completion | 00 = Always perform 8 byte partial DMA write |
| Mode = 00 | 01 = Do 128 byte Cache Inject, replicating 8 bytes across entire 128 byte |
| | cache line |
| | 10 = Do 128 byte DMA write, replicating 8 bytes across entire 128 byte |
| | cache line |
| | 11 = reserved |
| AMF CPB Write | Reserved (CPB write for AMF is not needed) |
| AMF Output Data | 0 = Always do DMA writes, full or partial based on number of bytes and |
| Write | alignment |
| | 1 = Do 128 byte Cache Inject when writing 128 aligned bytes, else do |
| | partial DMA write |
| 842 CSB Write | 00 = Always perform 8 or 16 byte partial DMA write |
| | 01 = Do 128 byte Cache Inject if CSB at end of cache line, else do partial |
| | DMA write |
| | 10 = Do 128 byte DMA write if CSB at end of cache line, else do partial |
| | DMA write |
| | 11 = reserved |
| 842 | 00 = Always perform 8 byte partial DMA write |
| Completion | 01 = Do 128 byte Cache Inject, replicating 8 bytes across entire 128 byte |
| Mode = 00 | cache line |
| | 10 = Do 128 byte DMA write, replicating 8 bytes across entire 128 byte |
| | cache line |
| | 11 = reserved |
| 842 CPB Write | 00 = Always do DMA writes, full or partial based on number of bytes and |
| | alignment |
| | 01 = Always do DMA writes, with partial on non-aligned cache lines and |
| | full 128 bytes on aligned cache lines (which may store dummy data at the |
| | end of the actual data) |
| | 10 = Do 128 byte Cache Inject when writing 128 aligned bytes, else do |
| | partial DMA write if not |
| | 11 = Do 128 byte Cache Inject when writing aligned cache lines (which |
| | may store dummy data at the end of the actual data), else do partial DMA |
| | writes if not aligned |
| 842 Output Data | 0 = Always do DMA writes, full or partial based on number of bytes and |
| Write | alignment |
| | 1 = Do 128 byte Cache Inject when writing 128 aligned bytes, else do |
| | partial DMA write |

Referring to Table 3, configuration fields and settings for controlling cache injection for a coprocessor using a DMA configuration register are shown. Each coprocessor acceleration engine has a dedicated bit field in the DMA configuration register which specifies actions to be taken with respect to cache injection. The interface signals detailed in Table 2 denote whether a cache injection is with respect to a partial or full cache line. If the partial attribute bit on the request interface is non-zero, a full cache line is still transmitted but the bridge fills in the unused bits of the cache line.

Once the DMA channel has received the CRB, it begins fetching the CPB input data and/or source data, depending on the type of coprocessor operation that is executing, into cacheline buffers internal to DMA. Assuming the case where the CPB is present, the engine, upon receiving the start signal, will make an input request for a quadword (QW) of CPB. The DMA channel transfers each QW of CPB data to the engine, accompanying each transfer with an acknowledge (ack).

The acceleration engine knows how many QWs comprise the CPB input area and signals to the DMA channel when a request is for the last QW of the CPB input. For some coprocessor types, only CPB data are required as inputs for the coprocessor operation. For coprocessor operations for which source data is required, the next input data request from acceleration engine to DMA will be for source data. The DMA channel transfers each QW of source data to the coprocessor acceleration engine, accompanying each with an acknowledge until the last source data QW, which the DMA channel knows from the length field in the data descriptor entries (SRCDDE), is transferred together with a “last data” indication. The coprocessor acceleration engine uses the source input data and the configuration data from the CPB to produce output data.

For outgoing data transfers, when an output QW of target data is available, the acceleration engine asserts an output request to the DMA channel. The DMA channel aligns the data within cacheline buffers according to the starting address of the destination. When a line of target data has been written into a cacheline buffer (or a partial line for the last output transfer), the DMA channel signals to the Bridge that a line is available to be written to storage. A RequesterID (unique per DMA channel) and relaxed ordering signal accompanies the transfer (These allow strict DMA write ordering to be enforced or not. For DMA writes of target data, relaxed ordering is allowed, i.e., the writes may proceed in any order). The address used is the TGTDDE address. The Bridge then performs the System Bus tasks necessary to properly store the line. This process continues until the acceleration engine has indicated that the last QW of target data has been transferred.

After having completed any target data transfers to DMA, the acceleration engine may then store updates to the CPB, providing the DMA channel with an offset into the CPB where the updates should start to be stored. The acceleration engine goes to an idle state after transferring the last CPB update, if any, to the DMA channel. When a line of CPB update data has been written into a cacheline buffer in the DMA (or a partial line for the last output transfer), the DMA channel signals to the PBI bridge that a cache line is available to be written to storage. The address used is the CSB address+the offset. The bridge then performs the system bus tasks necessary to properly store the cache line. This process continues until all of the CPB update data the engine provided has been transferred to the bridge.

The DMA channel then begins the completion phase. It issues a write request to the PBI bridge using the CSB address. The data contains a valid (V) bit and completion code (CC). A write to this location must be ordered after all the preceding DMA writes by this DMA channel are visible to the system. For this transfer, the DMA engine de-asserts the relaxed ordering signal and any earlier writes made by this RequesterID are completed before the present write may proceed. The PBI bridge handles the ordering.

The CRB may require additional steps to complete the coprocessor operation as specified in the completion method (CM) bits of the Coprocessor Completion Block (CCB). A second store of a completion value (CV) at a completion address (CA) may be required, or an interrupt may be required. In either case, the DMA channel, having decoded the CM bits, makes the request to the bridge. The second store is another DMA write. An interrupt is also another DMA write for which strict ordering applies. The DMA channel then signals to the bridge that it is done with this coprocessor request.

The types of write data produced by a specific hardware acceleration coprocessor is usually dependent on the type of function being performed by the coprocessor. Function-data type configuration settings for a coprocessor may define additional restrictions on when cache injection may be permitted. Depending on the coprocessor function, it may be advantageous to always perform a DMA transfer to system memory, also described as a non-cache injection write operation, if the write data is unlikely to be used by a processor. In which case there is no need to update or transfer that data into a processor cache. In such cases, cache injection may be disadvantageous as writing new data into a cache may cause another most recently used cache line to be expunged from the cache.

Still referring to Table 3, a cache-injection write may be performed if a full cacheline of write data has been generated by the coprocessor and is ready to be written and the starting address is on a cacheline boundary. The cache-injection write operation is typically used for Input Parameter Update data or output data that is likely to be referenced by a processor and therefore advantageous to be present in a processor's cache memory.

A full cacheline DMA write may be performed if less than a full cache line of write data has been generated, i.e. x bytes, where x<full cacheline) and is available, and the starting address is at the beginning of a cacheline. Trailing bytes after x bytes are don't care values with good ECC/parity if ECC/parity is required. Full cacheline DMA write operations are typically used for output data not likely to be referenced by a processor and to avoid the need for a read-modify-write of memory due to a partial cacheline write.

A cache-injection write may be performed if x bytes of write data are available, and the starting address is for last x bytes in a cacheline, and REM(cacheline size/x)=0, where REM is a remainder function. The data of concern is in the last x bytes of the cache line and whatever data resides in the leading byte field entries of the cacheline are unnecessary. The needed data is replicated and x evenly divides into a cache line, so the only reason for writing completion status is for the last QW of a cacheline. When a cache inject is made the other QW's are filled in with the same data because there must be data with good ECC otherwise an ECC error would result. The cache-injection write replicates x bytes for all data in cacheline and is typically used for Completion Status data.

A cache-injection write is typically used for Input Parameter Update data wherein if x bytes of write data are available and the starting address is at the beginning of a cacheline. If (x<full cacheline) The last write data transfer is replicated for all remaining data in cacheline to ensure valid ECC bits.

A cache-injection write may be performed if x bytes of write data are available, starting address is on an x byte boundary in cacheline, and REM(cacheline size/x)=0. The x bytes are replicated for all data in cacheline. The cache injection write is typically used for Additional Completion data.

Coprocessors make write requests to a write request arbiter that includes a request signal plus attribute fields. The data is in serial format and need not fit within a specific word size or prescribed boundary. The aggregate width of the data will be equal to the field widths. The format of the write request includes the signal and attribute fields, including address, bytecount, partial, RequestorID, new_flow, and cache-inject signals, etc.

New_flow is a flag asserted for the first write request of a coprocessor command. All writes produced by the execution of that command (i.e. flow) will use the same RequestorID. In other words each flow or processing thread executing on a coprocessor will have an associated requestor ID. However, a coprocessor can use multiple RequestorIDs so that writes from multiple commands it is executing can be pipelined and identified as belonging to a single command (flow). Nevertheless, the write arbiter will not allow a write request from a new flow to be sent to the bridge if all requestor IDs for that coprocessor are still in use, i.e., the writes have not completed. Regardless of what type of write request is made, the requestor ID is a finite resource allocated to each coprocessor. A person of skill in the art will appreciate the management of coprocessor resources for multiple instruction threads may be realized through a variety of implementations depending on the architecture specifications of the system and particular design constraints for a given application.

The partial flag is an attribute of the request for cache inject asserted for all requests not designated as full cacheline writes on the system bus. If the partial flag is deasserted and the bytecount is less than a full cacheline, the request on the system bus should be a full cacheline request.

Write data is transferred between the coprocessor and the bridge. For requests less than a full cacheline with the partial flag deasserted, the extra data not provided from the coprocessor is generated in the bridge by replicating the last write data transferred from the coprocessor to the bridge for the request. The appended data must have a valid ECC but is redundant.

The PBI bridge also has configuration settings for controlling cache injection. In this regard, cache injection may be disabled for a particular coprocessor regardless of the cache_inject setting in the coprocessor by setting the “disabled” flag in the bridge, which will override any settings in the coprocessor.

In “Individual Mode” each individual write request is made as CacheInject if the CacheInject attribute is asserted in the Coprocessor Write request. In “Flow Mode,” the CacheInject attribute of Coprocessor Write requests from the same Flow (RequestorID) can be modified by the response on the system bus to other Coprocessor Write requests from the same Flow. If a CacheInject Write Request is downgraded to a non-CacheInject in the bridge, all other CacheInject Write Requests currently or subsequently in the Bridge Request Queue belonging to the same Flow will also be issued on the system bus as non-CacheInject. If a non-CacheInject full cacheline Write Request is upgraded to a CacheInject, all other full cacheline Write Requests currently or subsequently in the Bridge Request Queue belonging to the same Flow will also be issued on the system bus as CacheInject. Finally, when a coprocessor write request with New_Flow attribute asserted enters the Bridge Request Queue, the previous Upgrade/Downgrade history for that RequestorID is cleared. A RequestorID is not re-used for a new flow until all writes for the previous flow with that RequestorID have completed.

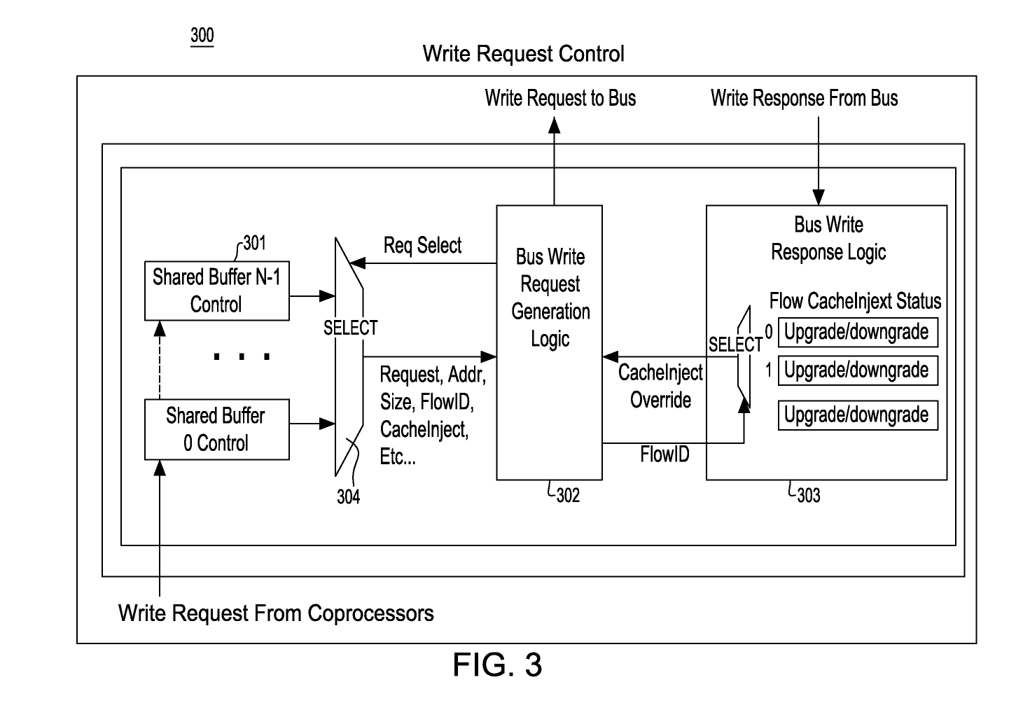

Referring to FIG. 3, a block level diagram of the write request cache inject control logic is shown for the bridge controller. Write request control 300 receives a write request from a coprocessor and stores the requestor flow ID, address and size in one of its n shared write buffers. Bus write request generation logic 302 selects one of the write requests stored in the n shared write buffers and directs the request to the main bus. Bus write response logic 303 receives a response from the bus and generates a cache inject override for a specific flow ID, which will either upgrade a DMA write to a cache inject write or down grade a cache inject write request to a DMA write.

TABLE 4
Table of cache injection controls for Bridge

| Config Field | Description |
|---|---|
| Cache Inject | 0x - Disable Cache Inject (no cache inject |
| Mode | commands will be used) |
| | 10 - Enable Individual Cache Inject Mode |
| | (the first part of the table) |
| | 11 - Enable Flow Cache Inject Mode (the |
| | last part of the table) |
| CL_DMA_W_T | If Cache Inject is Disabled |
| Mode | 0 - CL_DMA_W_I (retry the command using |
| | the Write I form of the command) |
| | 1 - CL_DMA_W_T (retry the command using |
| | the Write T form of the command |
| | If Cache Inject is Enabled |
| | 0 - CL_DMA_INJ (retry the command using |
| | the Cache Inject form of the command) |
| | 1 - CL_DMA_W_T (retry the command using |
| | the Write T form of the command |

Referring to Table 4, configuration fields and settings corresponding to cache injection controls for the bridge are shown. The PowerBus® Interface bridge logic currently supports two modes for decisions about sending the cache inject command to the PowerBus®. In “Flow Mode,” the PBI bridge will keep track of all commands for a given processing “flow,” i.e., commands using the same Requestor ID from the DMA logic. The command sent to the PowerBus® is based on the current state of some flow flags that are maintained by the PBI bridge. The PBI bridge will take into account the cache inject request from the DMA logic, which can be configured in the DMA Configuration Register as well as the Combined Responses received from previous commands associated with the same flow.

In “Individual Mode,” the PBI bridge only looks at the cache inject request from the DMA logic and the combined response from this command to make a decision about the cache inject command. The combined response is the collection of responses from all bus agents snooping the bus that indicates how the transfer can proceed. (i.e. a cache will accept the data or not) If the DMA has requested a cache injection and the combined response from this command allows it, the data is injected into the cache; if the combined response from this command does not allow cache injection, the command is reissued as a DMA write. Conversely, if the DMA has requested a DMA write and the combined response of all bus agents to the command allows a cache injection, then the command is reissued as a cache injection, otherwise, the write will proceed as a DMA write. The combined response represents the aggregate response from multiple bus agents to define how the bus operation may proceed and includes the caches on the bus snooping the command. The bus collects all responses and forwards them to the master that initiated the command, and, depending on the full response, the bridge may have to alter the response.

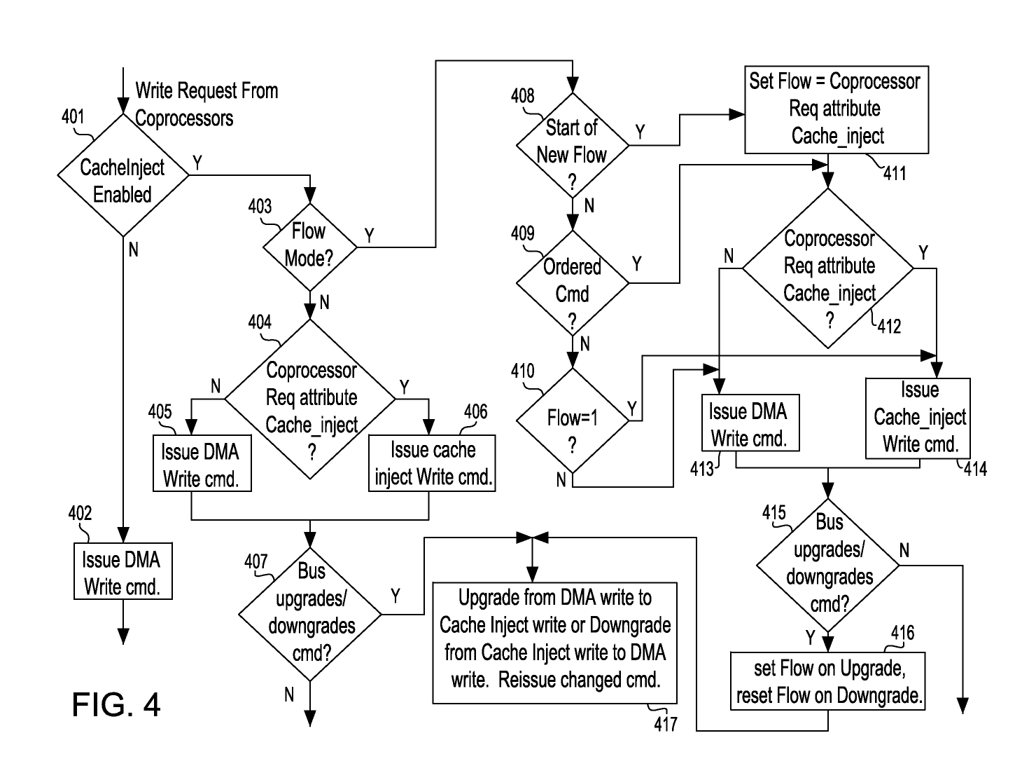

Referring to FIG. 4, write request inject control flow 400 is shown for the bridge controller. For each coprocessor write request, the bridge controller logic determines whether cache injection is enabled at step 401. If not, the write request is processed as a DMA write to main memory. If cache inject is enabled, the logic determines whether the write request belongs to an individual or flow mode at step 403. If an individual request, the bridge controller logic checks whether the coprocessor request attribute is set for cache inject at step 404. If the individual coprocessor attribute is not set for cache inject, the write request issues as a DMA write at step 405, else a cache inject command is issued at step 406. In either case, the bus may upgrade or downgrade the write request at step 407.

Also with reference to FIG. 4, if the bridge logic detects a flow mode write request at step 403, the bridge then checks whether the request is part of a new or existing flow at step 408. If the write request is associated with a new flow, the flow for that requestor ID is set to the coprocessor request cache inject attribute at step 411. Next the bridge checks whether the coprocessor request attribute is set to cache inject at step 412 and issues a cache inject command if so asserted at step 414. Continuing from step 414, the bridge logic tests whether a write request upgrade or down grade command has issued from the bus at step 415 and sets the cache inject attribute for that flow in response to an upgrade command and resets the flow in response to a downgrade command at step 416. Finally, the bridge logic will reissue the changed write command at step 417, if necessary.

Returning to step 408 shown in FIG. 4, if a new flow is not detected the bridge logic then tests for whether the write request is an ordered command. If yes, the flow moves to step 412 to test for the coprocessor request attribute being set for cache inject, else the logic tests for flow=1 at step 410 and proceeds to issue a cache inject write command at step 414 if flow=1, and a DMA write command if flow≠1 at step 413. Unordered commands are allowed to go out of order on PowerBus®; i.e. they can be issued and complete without regard to any other command issued by that PowerBus® master. An ordered command must wait for all earlier commands from the same Flow to complete before it can start on PowerBus®. Completion Status commands are ordered so that data produced by the engine is stored away before completion is reported.

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

It should further be understood that the terminology used herein is for the purpose of describing the disclosed embodiments only and is not intended to be limiting. As used herein, the singular forms “a”, “an” and “the” are intended to include the plural forms as well, unless the context clearly indicates otherwise. It should further be understood that the terms “comprises” “comprising”, “includes” and/or “including”, as used in this specification, specify the presence of stated features, integers, steps, operations, elements, and/or components, but do not preclude the presence or addition of one or more other features, integers, steps, operations, elements, components, and/or groups thereof. Additionally, it should be understood that the corresponding structures, materials, acts, and equivalents of all means or step plus function elements in the claims below are intended to include any structure, material, or act for performing the function in combination with other claimed elements as specifically claimed. The description above has been presented for purposes of illustration and description, but is not intended to be exhaustive or limited to the embodiments in the form disclosed. Many modifications and variations to the disclosed embodiments will be apparent to those of ordinary skill in the art without departing from the scope and spirit of the disclosed embodiments.

What is claimed is:

1. In a multi-processor computer system with shared memory resources having a hierarchical bus architecture facilitating transfer of data between a plurality of agents coupled to the bus, a method of selectively performing cache injection of data generated by a coprocessor hardware accelerator, comprising:
providing a configuration register in the coprocessor hardware accelerator to identify types of write data for which cache injection will be requested;
issuing a request for cache injection from a first coprocessor hardware accelerator in which a requestor identifier is associated with a first processing job/flow; and
maintaining a history table of cache injection write operations performed with respect to the first processing flow in a bridge controller coupled to the bus through which all requests for cache injection are made, wherein the bridge controller may override the request for cache injection based on whether previously cache injected data was accepted by a cache of a processor core coupled to the bus.

2. The method according to claim 1, wherein the bridge controller down grades the request for cache injection to a non-cache injection memory transfer, such as a direct memory access (DMA) transfer, based on whether the cache of a processor core accepted a previously cache injected cache line.

3. The method according to claim 1, wherein the bridge controller upgrades the request for non-cache injection (DMA) to a cache injection memory transfer, based on whether the cache of a processor core accepted a previously cache injected cache line.

4. The method according to claim 1, wherein the coprocessor hardware accelerator is coupled to a bridge having n local shared write buffers to which coprocessor output data and requestor ID information is written.

5. The method according to claim 1, wherein the coprocessor hardware accelerator further comprises m local write data cacheline buffers to hold different types of write data.

6. the method according to claim 5, wherein the different write data types comprise output data from the coprocessor function; updates to input parameter data fetched and provided to the coprocessor hardware accelerator; completion status of the coprocessor operation; and additional completion data.

7. A multi-processor computer system with shared memory resources, comprising:
a bus to facilitate transfer of address and data between multiple agents coupled to the bus;
a plurality of multi-processor nodes, each having one or more processor cores connected thereto;
a memory subsystem associated with each one of the plurality of multi-processor nodes;
a local cache associated with each one of the one or more processor cores;
a bridge device facilitating transfer of data between shared memory resources, wherein the bridge device maintains a plurality of configuration settings for cache injection of write data and includes a set of shared write data buffers used for write requests to memory;
a plurality of coprocessor hardware accelerators, each coprocessor hardware accelerator having one or more dedicated processing functions and a configuration register to record settings for cache injection;
a direct access memory (DMA) controller to manage data flow to and from the plurality of coprocessor hardware accelerators; and
a plurality of local write buffers associated with each one of the plurality of coprocessor hardware accelerators.

8. The computer system according to claim 7, where the write data comprises output from a coprocessor hardware accelerator.

9. The computer system according to claim 7, where the write data comprises input parameter update data.

10. The computer system according to claim 7, where the write data comprises completion status data.

11. The computer system according to claim 7, where the write data comprises additional completion data.

12. The computer system according to claim 7, wherein the DMA controller further comprises multiple channels assignable to one or more coprocessor hardware accelerators.

13. The computer system according to claim 7, wherein the plurality of local write buffers are co-located with the DMA controller.

14. The system according to claim 7, further comprising a write request arbiter to control the priority for addressing write requests by the plurality of coprocessor hardware accelerators.

15. In a multi-processor computer system employing cache injection of write data generated by a coprocessor hardware accelerator, a method of selectively controlling when data generated by a coprocessor hardware accelerator is written to a cache memory, comprising
receiving a write request from a first coprocessor hardware accelerator;
determining whether a cache inject option flag is set in the coprocessor write request;
initiating a direct memory access transfer for the data generated by the first coprocessor if the cache inject option flag is not set;
checking whether the write request belongs to a new processing flow, or carries a previously issued requester ID.
issuing a cache inject write command to a bridge controller facilitating data transfer between the plurality of coprocessor hardware accelerators and the bus for the write data generated by the first coprocessor hardware accelerator if the cache inject flag is set;
issuing a DMA write command if the cache inject option flag is not asserted in the coprocessor write request;
checking whether a bus upgrade request has been issued for the write data associated with the first write request command;
issuing a cache inject write command for the write data generated by the first coprocessor hardware accelerator if the cache inject flag is upgraded by the bridge; and
issuing a DMA write command if a bus downgrade command has been issued for the write data associated with the first write request.

16. The method according to claim 15, further comprising determining whether a write operation associated with a first coprocessor hardware accelerator should be cache injected based on the function the first coprocessor is performing and configuration bits.

17. The method according to claim 15, further comprising performing a cache injection based on the type of data the first coprocessor is writing to the memory.

18. The method according to claim 15 further comprising determining whether a write request should attempt a cache injection based on the alignment and amount of data to be written. i.e. full cacheline write is available or partial cache line write, in which the data begins on a cache line boundary or not, or the data is appended to the end of a quad word.

19. The method according to claim 15, further comprising using past history of cache injection write status to determine if other write requests belonging to a set of write requests should be attempted as cache injection.

20. The method according to claim 15, further comprising determining whether a partial write of a cacheline may be issued as a full cacheline write.

21. The method according to claim 15, further comprising providing the additional write data for a partial write of a cacheline that is issued as a full cacheline write by substituting null/don't care values in unoccupied bit fields in the cache line of write data.

22. The method according to claim 15 further comprising performing a cache injection when a full cache line of write data is available and begins on a cache line boundary.

23. The method according to claim 15 further comprising performing a cache injection when a partial cache line of write data is available and begins on a cache line boundary.

24. The method according to claim 15 further comprising performing a cache injection when a partial cache line of write data is available and is appended to the end of a cache line or quadword.

25. A computer system: comprising:
a bus;
a memory attached to the bus;
agents coupled to the bus for writing data to the memory, one or more of the agents comprising a processor with associated cache memory, a bridge comprising a set of shared write data buffers used for write requests to memory;
a plurality of coprocessors, each one making write requests for multiple types of data;
a write data control logic element to arbitrate between the plurality of coprocessors to pass requests to the bridge logic and move the write data from the coprocessor to the bridge.
